(19) United States
(12) Patent Application Publication
(10) Pub. No.: US 2015/0326630 A1
(43) Pub. Date: Nov. 12, 2015

(54) METHOD FOR STREAMING VIDEO IMAGES AND ELECTRICAL DEVICE FOR SUPPORTING THE SAME

(71) Applicant: Samsung Electronics Co., Ltd., Gyeonggi-do (KR)

(72) Inventor: Tae Hyung KIM, Gyeonggi-do (KR)

(73) Assignee: Samsung Electronics Co., Ltd.

(21) Appl. No.: 14/657,737

(22) Filed: Mar. 13, 2015

(30) Foreign Application Priority Data
May 8, 2014 (KR) 10-2014-0055047

(51) Int. Cl. H04L 29/06

(52) U.S. Cl. CPC H04L 65/4069; H04L 65/601; H04L 65/607

(57) ABSTRACT

A video streaming method is provided. The method includes generating image information related to a frame of an image, generating an image packet by packetizing the generated image information, transmitting a transmission packet corresponding to the image packet, and transmitting at least one transmission packet corresponding to an additional packet for indicating a boundary of the image packet. The video streaming method is applicable to other embodiments.

### PRIORITY

This application claims priority under 35 USC §119(a) to Korean Patent Application No. 10-2014-0055047, filed on May 8, 2014, in the Korean Intellectual Property Office, the entire disclosure of which is incorporated herein by reference.

### BACKGROUND

1. Field of the Invention

The present invention relates generally to a video streaming method performed in an electronic device.

2. Description of the Related Art

In general, a video streaming technology allows an electronic device to transmit images to another electronic device so that the images are played therein. Recently, by virtue of a mirroring technology applied to smartphones or tablets, image data output through a smartphone, or the like, may also be output through another electronic device (e.g., a TV, a monitor, etc.).

According to the above-mentioned conventional technology, when signals are transmitted or received to stream images, the signals are delayed by a certain amount of time due to a buffering process. Moreover, when an amount of data generated in a single frame exceeds a predetermined value, an additional delay occurs while the data is processed.

### SUMMARY

The present invention has been made to address at least the problems and disadvantages described above, and to provide at least the advantages described below.

Accordingly, an aspect of the present invention is to provide a video streaming method, and an electronic device supporting the same, for streaming image signals without delay by adding an additional predetermined packet between image signal data.

In accordance with an aspect of the present invention, a video streaming method is provided. The method includes generating image information related to a frame of an image, generating an image packet by packetizing the generated image information, transmitting a transmission packet corresponding to the image packet, and transmitting at least one transmission packet corresponding to an additional packet for indicating a boundary of the image packet.

In accordance with another aspect of the present invention, a video streaming method is provided. The method includes receiving a transmission packet for an image packet related to a frame of an image, receiving a transmission packet corresponding to an additional packet indicating a boundary of the image packet, extracting the image packet with reference to the additional packet, and configuring the image on the basis of the image packet.

In accordance with yet another aspect of the present invention, an electronic device is provided. The electronic device includes an encoding module configured to generate image information related to a frame of an image, a packetizing module configured to generate an image packet by packetizing the generated image information, a transmission packet generating module configured to generate a transmission packet corresponding to the image packet, and a communication interface configured to transmit the transmission packet to another electronic device, and after the transmission packet is transmitted, to transmit at least one transmission packet corresponding to an additional packet for indicating a boundary of the image packet.

In accordance with yet another aspect of the present invention, an electronic device is provided. The electronic device includes a communication module configured to receive a transmission packet for an image packet related to a frame of an image, and after receiving the transmission packet for the image packet, to receive a transmission packet corresponding to an additional packet for indicating a boundary of the image packet, a transmission packet converting module configured to extract the image packet from the transmission packet and to refer to the additional packet to configure the image packet, and a decoding module configured to extract image information related to the frame from the image packet.

In accordance with yet another aspect of the present invention, a non-transitory computer-readable storage medium having instructions recorded thereon for controlling an electronic device is provided. The instructions allow the electronic device to perform the steps of generating image information related to a frame of an image, generating an image packet by packetizing the generated image information, transmitting a transmission packet corresponding to the image packet, and transmitting at least one transmission packet corresponding to an additional packet for indicating a boundary of the image packet.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a network environment, including an electronic device, according an embodiment of the present invention;

FIG. 2 is a block diagram illustrating a video streaming module, according to an embodiment of the present invention;

FIG. 3 is a flowchart illustrating a video streaming method, according to an embodiment of the present invention;

FIG. 4 is a diagram illustrating a stream of image packets, according to an embodiment of the present invention;

FIG. 5 is a diagram illustrating a packet configuration for describing a process of converting an image packet, according to an embodiment of the present invention;

FIG. 6 is a diagram illustrating a packet configuration for indicating a change of a packet start indicator in a packet stream, according to an embodiment of the present invention;

FIG. 7 is a diagram illustrating a packet configuration for showing a format of data included in a payload of an additional packet, according to an embodiment of the present invention;

FIG. 8 is a diagram illustrating a packet streaming configuration when a plurality of additional packets is added within a predetermined time interval, according to an embodiment of the present invention;

FIG. 9 is a diagram illustrating a packet streaming configuration when an additional packet is added by a transmission packet generating module, according to an embodiment of the present invention;

FIG. 10 is a block diagram illustrating a video receiving module included in an external electronic device for receiving images, according to an embodiment of the present invention;

FIG. 11 is a diagram illustrating a packet streaming configuration for the case where an additional packet is added by a transmission packet generating module, according to an embodiment of the present invention;

FIGS. 12A to 12C are diagrams illustrating screens of an electronic device, including data streamed in an additional packet, according to an embodiment of the present invention; and

FIG. 13 is a block diagram illustrating an electronic device, according to an embodiment of the present invention.

### DETAILED DESCRIPTION OF EMBODIMENTS OF THE PRESENT INVENTION

Hereinafter, embodiments of the present invention will be described with reference to the accompanying drawings. The present invention may be variously modified and may include various embodiments. However, specific embodiments are illustrated, by example, in the drawings and detailed descriptions related thereto are provided. However, it should be understood that the various embodiments of the present invention are not limited to specific examples, but rather include all modifications, equivalents and alternatives that fall within the sprit and scope of the embodiments of the present invention. Regarding the drawings, like reference numerals refer to like elements.

The terms “include,” “comprise,” “including,” or “comprising” used herein indicate disclosed functions, operations, or existence of elements but does not exclude other functions, operations, or elements. It should be further understood that the terms “include”, “comprise”, “have”, “including”, “comprising”, or “having” used herein specify the presence of stated features, integers, steps, operations, elements, components, or combinations thereof but does not preclude the presence or addition of one or more other features, integers, steps, operations, elements, components, or combinations thereof.

The meaning of the term “or” used herein includes any combination of words connected by the term “or”. For example, the expression “A or B” may indicate A, B, or both A and B.

The terms such as “first”, “second”, and the like used herein may refer to various elements of the embodiments of the present invention, but do not limit the elements. For example, such terms do not limit the order and/or priority of the elements. Furthermore, such terms may be used to distinguish one element from another element. For example, “a first user device” and “a second user device” indicate different user devices. For example, without departing from the scope of the embodiments of the present invention, a first element may be referred to as a second element or vice versa.

It will be understood that when an element is referred to as being “connected” or “coupled” to another element, it can be directly connected or coupled to the other element or intervening elements is present. In contrast, when an element is referred to as being “directly connected” or “directly coupled” to another element, it should be understood that there are no intervening elements.

The terminology used herein is not for limiting the embodiments of the present invention, but for describing specific examples of the present invention. The terms of a singular form may include plural forms unless otherwise specified.

The terms used herein, including technical or scientific terms, have the same meanings as understood by those skilled in the art, unless otherwise defined herein. The commonly used terms, such as those defined in a dictionary, should be interpreted in the same context as in the related art and should not be interpreted in an idealized or overly formal sense, unless otherwise defined explicitly.

Electronic devices according to the embodiments of the present invention may have a communication function. For example, the electronic devices may include at least one of smartphones, tablet Personal Computers (PCs), mobile phones, video telephones, electronic book readers, desktop PCs, laptop PCs, netbook computers, Personal Digital Assistants (PDAs), Portable Multimedia players (PMPs), MP3 players, mobile medical devices, cameras, wearable devices (e.g., Head-Mounted-Devices (HMDs), such as electronic glasses), electronic apparel, electronic bracelets, electronic necklaces, electronic appcessories, electronic tattoos, and smart watches.

According to certain embodiments, the electronic devices may be smart home appliances having a communication function. The smart home appliances may include at least one of, for example, TVs, Digital Versatile Disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, and electronic picture frames.

According to certain embodiments, the electronic devices may include at least one of medical devices (e.g., Magnetic Resonance Angiography (MRA), Magnetic Resonance Imaging (MRI), Computed Tomography (CT), scanners, and ultrasonic devices), navigation devices, Global Positioning System (GPS) receivers, Event Data Recorders (EDRs), Flight Data Recorders (FDRs), vehicle infotainment devices, electronic equipment for ships (e.g., navigation systems and gyrocompasses), avionics, security devices, head units for vehicles, industrial or home robots, Automatic Teller's Machines (ATMs), and Points Of Sale (POS) devices.

According to certain embodiments, the electronic devices may include at least one of parts of furniture or buildings/structures having communication functions, electronic boards, electronic signature receiving devices, projectors, and measuring instruments (e.g., water meters, electricity meters, gas meters, and wave meters). The electronic devices, according to the embodiments of the present invention, may be one or more combinations of the above-mentioned devices. Furthermore, the electronic devices, according to the embodiments of the present invention, may be flexible devices. It would be obvious to those skilled in the art that the electronic devices, according to the embodiments of the present invention, are not limited to the above-mentioned devices.

Hereinafter, a video streaming technology, according to the embodiments of the present invention, will be described with reference to the accompanying drawings. The term “user” used herein refers to a person who uses an electronic device or to a device (e.g., an artificial electronic device) which uses an electronic device.

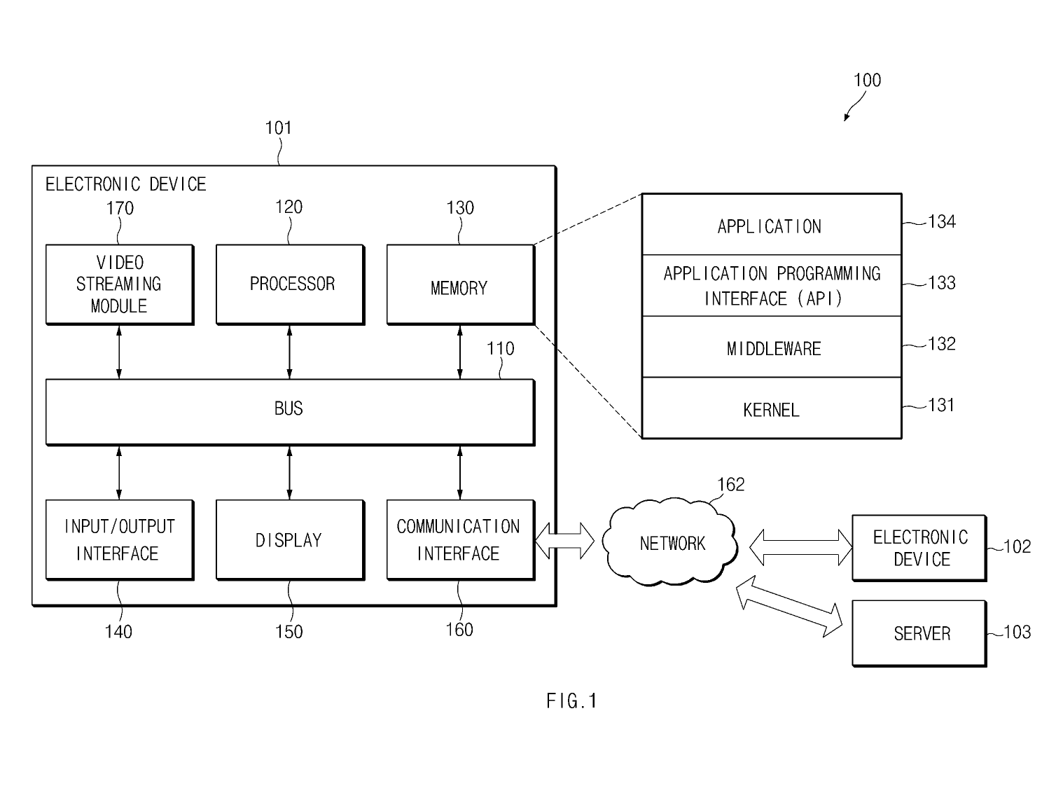

FIG. 1 is a block diagram illustrating a network environment, including an electronic device, according to an embodiment of the present invention.

Referring to FIG. 1, electronic device 101 is provided. The electronic device 101 includes a bus 110, a processor 120, a memory 130, an input/output interface 140, a display 150, a communication interface 160, and a video streaming module 170.

The bus 110 is a circuit for connecting the above-mentioned elements of the electronic device 101 to each other and for communication (e.g., control message transfer) between the above-mentioned elements.

The processor 120 receives a command from another element (e.g., the memory 130, the input/output interface 140, the display 150, the communication interface 160, or the video streaming module 170) through the bus 110, interprets the received command, and performs an operation or data processing according to the interpreted command.

The memory 130 stores a command or data received from or generated by the processor 120 or another element (e.g., the input/output interface 140, the display 150, the communication interface 160, or the video streaming module 170). The memory 130 includes programming modules, such as a kernel 131, middleware 132, an application programming interface (API) 133, or an application 134. Each programming module may include software, firmware, hardware, or a combination of at least two thereof.

The kernel 131 controls or manages system resources (e.g., the bus 110, the processor 120 or the memory 130) used to perform an operation or function of another programming module, for example, the middleware 132, the API 133, or the application 134. Furthermore, the kernel 131 may provide an interface for the middleware 132, the API 133 or the application 134 to access individual elements of the electronic device 101 in order to control or manage the elements.

The middleware 132 serves as an intermediary between the API 133 or application 134 and the kernel 131, so that the API 133 or application 134 communicates and exchanges data with the kernel 131. Furthermore, the middleware 132 performs a control operation (e.g., scheduling or load balancing) with respect to operation requests received from the application 134 by using, e.g., a method of assigning a priority for using system resources (e.g., the bus 110, the processor 120 or the memory 130) of the electronic device 101 to at least one application 134.

The API 133, which is an interface for the application 134 to control a function provided by the kernel 131 or middleware 132, includes at least one interface or function (e.g., a command) for file control, window control, image processing, or character control, for example.

The application 134 may include an SMS/MMS application, an electronic mail application, a calendar application, an alarm application, a health care application (e.g., an application for measuring an amount of exercise or blood sugar), or an environment information application (e.g., an application for providing atmospheric pressure, humidity, or temperature information). Additionally or alternatively, the application 134 may be an application related to information exchange between the electronic device 101 and an external electronic device (e.g., an electronic device 102 or a server 103). The application related to information exchange may include, for example, a notification relay application for transferring specific information to the external electronic device or a device management application for managing the external electronic device.

For example, the notification relay application may include a function of transferring notification information generated by another application (e.g., an SMS/MMS application, an electronic mail application, a health care application, or an environment information application) to an external electronic device (e.g., the electronic device 102). Additionally or alternatively, the notification relay application may receive notification information from an external electronic device (e.g., the electronic device 102) and may provide the notification information to a user.

The device management application may manage (e.g., install, uninstall or update) a function (e.g., turning on/off an external electronic device (or a component thereof) or adjusting brightness (or resolution) of a display) of at least a part of the external device (e.g., the electronic device 102 or the server 103), an application operated in the external electronic device, or a service (e.g., a call service or a messaging service) provided from the external electronic device.

The application 134 may include a designated application according to an attribute (e.g., the type of an electronic device) of the external electronic device (e.g., the electronic device 102). For example, if the external electronic device is an MP3 player, the application 134 may include an application related to playback of music. Similarly, if the external electronic device is a mobile medical device, the application 134 may include an application related to health care. The application 134 may include at least one of an application designated for the electronic device 101 and an application received from an external electronic device (e.g., the electronic device 102).

The input/output interface 140 transfers a command or data input by a user through an input/output device (e.g., a sensor, a keyboard, or a touch screen) to the processor 120, the memory 130, the communication interface 160, or the video streaming module 170 through, for example, the bus 110. For example, the input/output interface 140 may provide, to the processor 120, data about a touch of a user on a touch screen. Furthermore, the input/output interface 140 may output, through the input/output device (e.g., a speaker or a display), for example, the command or data received from the processor 120, the memory 130, the communication interface 160, or the data streaming module 170, through the bus 110. For example, the input/output interface 140 may output voice data processed by the processor 120 to a user through a speaker.

The display 150 displays various information (e.g., multimedia data or text data) to a user. For example, the display 150 may output a streaming image.

The communication interface 160 establishes communication between the electronic device 101 and an external electronic device (e.g., the electronic device 102 or the server 103). For example, the communication interface 160 may be connected to a network 162 wirelessly or by wire so as to communicate with the external electronic device. The wireless communication may include at least one of WiFi communication, Bluetooth (BT) communication, Near Field Communication (NFC), GPS or cellular communication (e.g., Long Term Evolution (LTE), Long Term Evolution Advanced (LTE-A), Code Division Multiple Access (CDMA), Wideband Division Multiple Access (WCDMA), Universal Mobile Telecommunications System (UMTS), Wireless Broadband (WiBro), or Global System for Mobile (GSM)). The wired communication may include at least one of Universal Serial Bus (USB) communication, High Definition Multimedia Interface (HDMI) communication, Recommended Standard 232 (RS-232) communication, and Plain Old Telephone Service (POTS) communication.

The communication interface 160 transmits, to an external electronic device 102 or 103, data related to an image generated through the video streaming module 170. Furthermore, the communication interface 160 may additionally transmit related information that may be displayed or processed together with the data.

The network 162 may be a telecommunications network. The telecommunications network may include at least one of a computer network, the Internet, the Internet of Things, and a telephone network. According to an embodiment of the present invention, a protocol (e.g., a transport layer protocol, a data link layer protocol or a physical layer protocol) for communication between the electronic device 101 and an external electronic device is supported by at least one of the application 134, the application programming interface 133, the middleware 132, the kernel 131, and the communication interface 160.

The video streaming module 170 performs data processing for streaming and outputting an image (e.g., a movie or game screen) to an external electronic device 102 or 103. The image may correspond to multimedia data stored in the electronic device 101 or streamed to the electronic device 101 and output through the display 150. The video streaming module 170 may additionally process audio data, text data, or User Interface (UI) data related to the image.

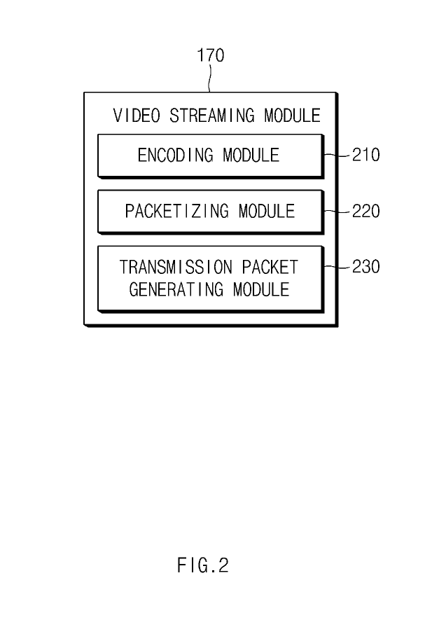

The video streaming module 170 provides converted data or processed data to an external electronic device (e.g., the electronic device 102 or the server 103) through the communication interface 160. The video streaming module 170 will be described in more detail with reference to FIG. 2.

The electronic device 101 may perform a pre-interworking operation with an external electronic device 102 or 103 in order to stream images. The pre-interworking operation includes requesting, by the electronic device 101, the external electronic device to confirm whether to receive an image, or receiving an image transmission request from the external electronic device. Each electronic device may form a security network and exchange network identifiers to perform the pre-interworking operation for streaming images. When the pre-interworking operation is completed, the electronic device 101 streams the image data generated by the video streaming module 170 to the external electronic device.

FIG. 2 is a block diagram illustrating the video streaming module, according to an embodiment of the present invention.

Referring to FIG. 2, the video streaming module 170 is provided. Video streaming module 170 includes an encoding module 210, a packetizing module 220, and a transmission packet generating module 230.

The encoding module 210 generates image information related to a frame of an image. The encoding module 210 converts screen information (e.g., a pixel value, brightness, or saturation of a screen) or audio information related to a frame into the image information, according to a preset standard. The image information corresponds to data obtained by compressing the screen information or the audio information through an image processing operation. The image information corresponds to an Elementary Stream (ES), according to Moving Picture Experts Group-2 (MPEG-2).

The packetizing module 220 packetizes the image information generated by the encoding module 210, to convert the image information into an image packet according to a preset standard. The packetizing module 220 adds to the image information, a header including information, such as a length and stream type of the image information, to generate the image packet. The image packet generated by the packetizing module 220 includes a header and a payload. The header includes information on the image packet (e.g., an image packet start indicator, a packet length, or a stream type). The payload includes the image information (e.g., screen information or audio information) related to a frame of an image. The image packet corresponds to a Packetized Elementary Stream (PES) according to MPEG-2.

The packetizing module 220 may generate an additional packet. The additional packet is arranged between image packets which are streamed at certain intervals. The additional packet corresponds to a packet that indicates an image packet boundary or provides information related to an image packet. An external electronic device 102 or 103 which receives image data, uses the additional packet to determine the image packet boundary, and processes an image packet received before the additional packet is received. Furthermore, the external electronic device checks data included in the payload of the additional packet to display the data together with streamed image data on a screen.

The transmission packet generation module 230 converts each of the image packet and the additional packet into at least one transmission packet. The transmission packet corresponds to a packet obtained by converting the image packet so that the image packet is easily transmitted/received in a communication network environment. The transmission packet corresponds to a Transport Stream (TS) according to MPEG-2.

The above-mentioned classification of operations is merely a functional classification, and the operations performed by the video streaming module 170 may be implemented by a single process. In addition, the video streaming module 170 may be implemented by adding an additional module. For example, the video streaming module 170 may be implemented by adding an additional communication module that performs a part of the operations performed by the communication interface 160.

According to an embodiment of the present invention, the electronic device 101 may include an encoding module for generating image information related to a frame of an image, a packetizing module for generating an image packet by packetizing the generated image information, a transmission packet generating module for generating a transmission packet corresponding to the image packet, and a communication interface for transmitting the transmission packet to another electronic device, wherein, after the transmission packet is transmitted, the communication interface transmits at least one transmission packet corresponding to an additional packet for indicating a boundary of the image packet.

According to the various embodiments, an electronic device 101 may include a communication module for receiving a transmission packet for an image packet related to a frame of an image, a transmission packet converting module for extracting the image packet from the transmission packet, and a decoding module for extracting image information related to the frame from the image packet. The communication module receives an additional packet, indicating a boundary of the image packet, after receiving the transmission packet for the image packet. The transmission packet converting module refers to the additional packet to configure the image packet.

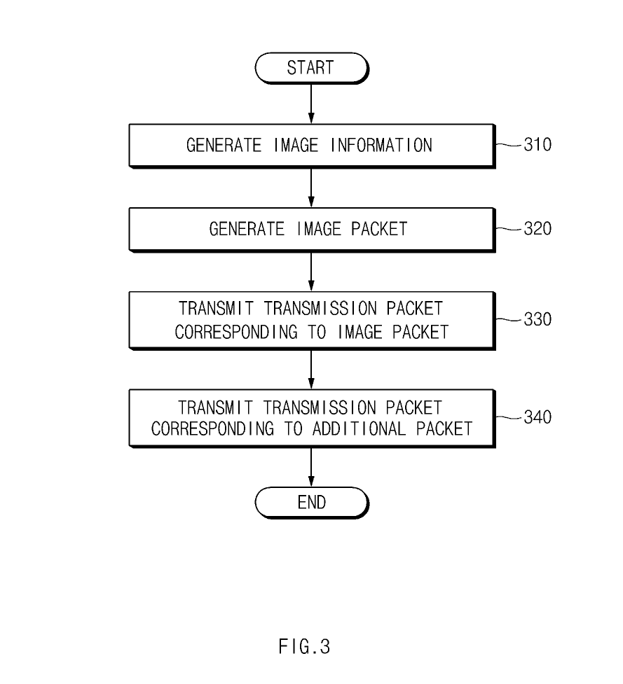

FIG. 3 is a flowchart illustrating a video streaming method, according to an embodiment of the present invention.

Referring to FIG. 3, in step 310, the encoding module 210 generates image information related to a frame of an image. The image is implemented by outputting frames corresponding to paused screens at an interval of a certain time. The encoding module 210 converts screen information or audio information for each frame of the image into image information according to a preset standard. The image information corresponds to an ES according to MPEG-2.

In step 320, the packetizing module 220 packetizes the image information generated by the encoding module 210 to generate an image packet. The image packet includes a header and a payload. The header includes information on the image packet (e.g., an image packet start indicator, a packet length, or a stream type). The payload includes the image information (e.g., screen information or audio information) related to a frame of an image. The image packet corresponds to a PES according to MPEG-2.

The packetizing module 220 generates an additional packet. The additional packet corresponds to a packet that indicates an image packet boundary or provides information related to an image packet. The additional packet is converted into a corresponding transmission packet through the transmission packet generating module 230. The additional packet may have such a size as to be transmitted within a preset time interval related to an image characteristic. For example, in the case where the image has a characteristic of 30 fps, the additional packet may be configured to have such a size as to be transmitted within 1000/30 ms (about 33 ms) corresponding to a time interval between frames.

In step 330, the transmission packet generation module 230 converts the image packet into at least one transmission packet. The transmission packet corresponds to a packet having such a format as to be easily transmitted/received in a communication network environment. The transmission packet is generated by dividing the image packet into certain sections and adding a header. The obtained transmission packet is transmitted to an external electronic device (e.g., the electronic device 102 or the server 103) through the communication interface 160. The transmission packet corresponds to a TS according to MPEG-2.

In step 340, the transmission packet generating module 230 generates at least one transmission packet corresponding to the additional packet and transmits the generated transmission packet to an external electronic device (e.g., the electronic device 102 or the server 103). In the case where consecutive image packets are sequentially streamed, the additional packet may be arranged between time intervals generated between image packets and be transmitted to the external electronic device.

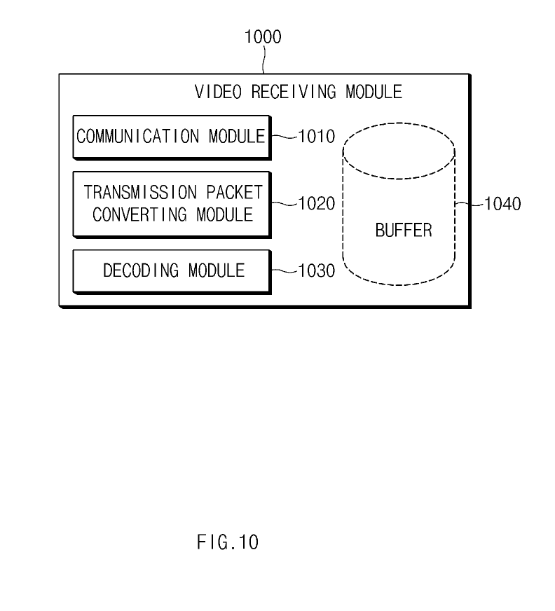

The external electronic device for receiving images checks the additional packet between image packets to determine that all the data about previously received image packets have been received. The external electronic device processes received image packets without an additional delay by checking the content of the additional packet alone without checking image packets received after a lapse of a certain interval of time. The operation of the external electronic device for receiving images will be described in more detail with reference to FIGS. 10 to 13.

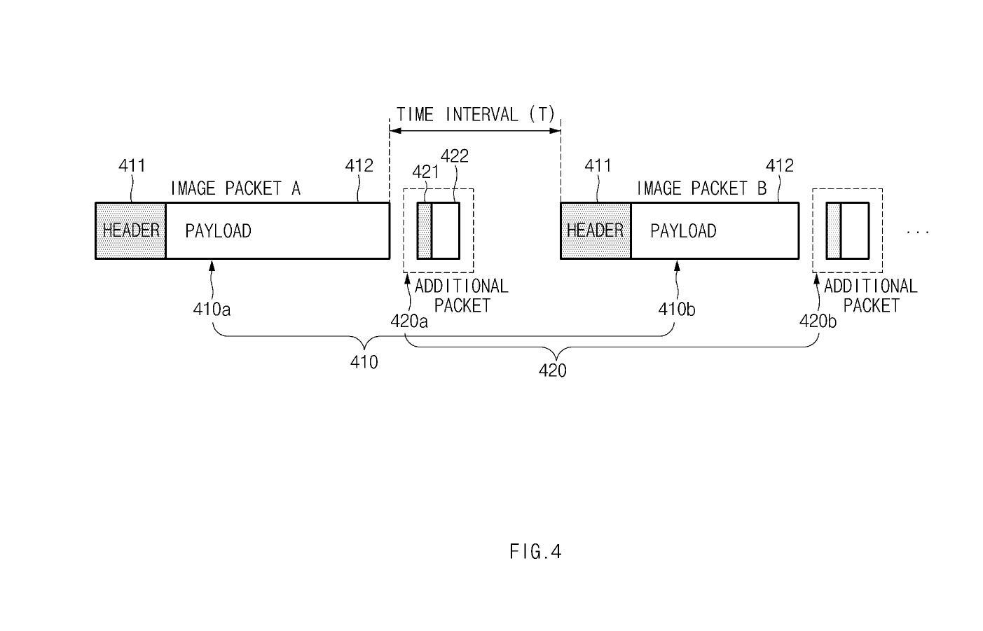

The additional packet may be generated by the packetizing module 220 and be transmitted after being converted into a form of a transmission packet, or may be generated by the transmission packet generating mode 230 in the form of a transmission packet and then be transmitted. Hereinafter, the generation or transmission of the additional packet will be described with reference to FIGS. 4 to 10.

FIG. 4 is a diagram illustrating a stream of image packets, according to an embodiment of the present invention.

Referring to FIG. 4, an image packet 410 (e.g., image packets 410a and 410b) is streamed at a certain time interval T. The time interval T is determined according to an output characteristic of images. For example, in the case where the images have a rate of 30 fps, the time interval T may have a value of 1000/30 ms (about 33 ms) corresponding to a time interval between frames. In the case where the images have a rate of 15 fps, the time interval T may have a value of 1000/15 ms (about 67 ms) corresponding to a time interval between frames.

Each image packet 410 includes a header 411 and a payload 412. The header 411 includes information on the image packet (e.g., an image packet start indicator, a packet length, or a stream type). In the case of MPEG-2, a packet length indicator has a size of 2 bytes. This indicator identifies the length of the image packet within a range of 1-65535 bits, and may be filled with a predetermined value (e.g., 0) if the length exceeds the range. The payload 412 includes the image information (e.g., screen information or audio information) related to frames that constitute images.

There may be a one-to-one correspondence between each image packet 410 and each frame images. For example, the image packet 410a may correspond to a first frame of the images and the image packet 410b may correspond to a second frame of the images. Each image packet 410 has a length which varies with an amount of data included in a matched frame. For example, the first frame may correspond to the image packet 410a obtained by packetizing data that corresponds to a screen having a large variation of brightness or saturation and thus has a size greater than a predetermined size (e.g., 65535 bits). On the contrary, the second frame may correspond to the image packet 410b corresponding to a simple change of black color and having a size not greater than the predetermined size (e.g., 65535 bits). In another example, the first frame may correspond to the image packet 410a that corresponds to a reference frame for a frame change, i.e., an intra frame, and thus includes a relatively large amount of data. The second frame may correspond to a predicted frame that only includes data changed in the reference frame, and thus, includes a smaller amount of data than that of the first frame.

An additional packet 420 (e.g., an additional packet 420a or 420b) is arranged, within the time interval T, between images packets 410 in order to be streamed. The additional packet 420 is transmitted within the time interval T to indicate a boundary of the image packet 410. When an external electronic device 102 or 103 for receiving video data confirms the reception of the additional packet 420a, the external electronic device determines that the image packet 410a received immediately before the reception of the additional packet has been completely received. The external electronic device processes data for the image packet 410a before receiving the image packet 410b to reduce a streaming latency. However, according to the prior art, the additional packet is not added. Therefore, in the prior art, even after the reception of the image packet 410a is completed, the packet start indicator of the image packet 410b received after a lapse of the time interval T is checked and then the image packet 410a is processed, causing an increase of the streaming latency.

Like the image packet 410, the additional packet 420 includes a header 421 and a payload 422. The additional packet 420 has the same format as that of the image packet 410, but does not include additional image information.

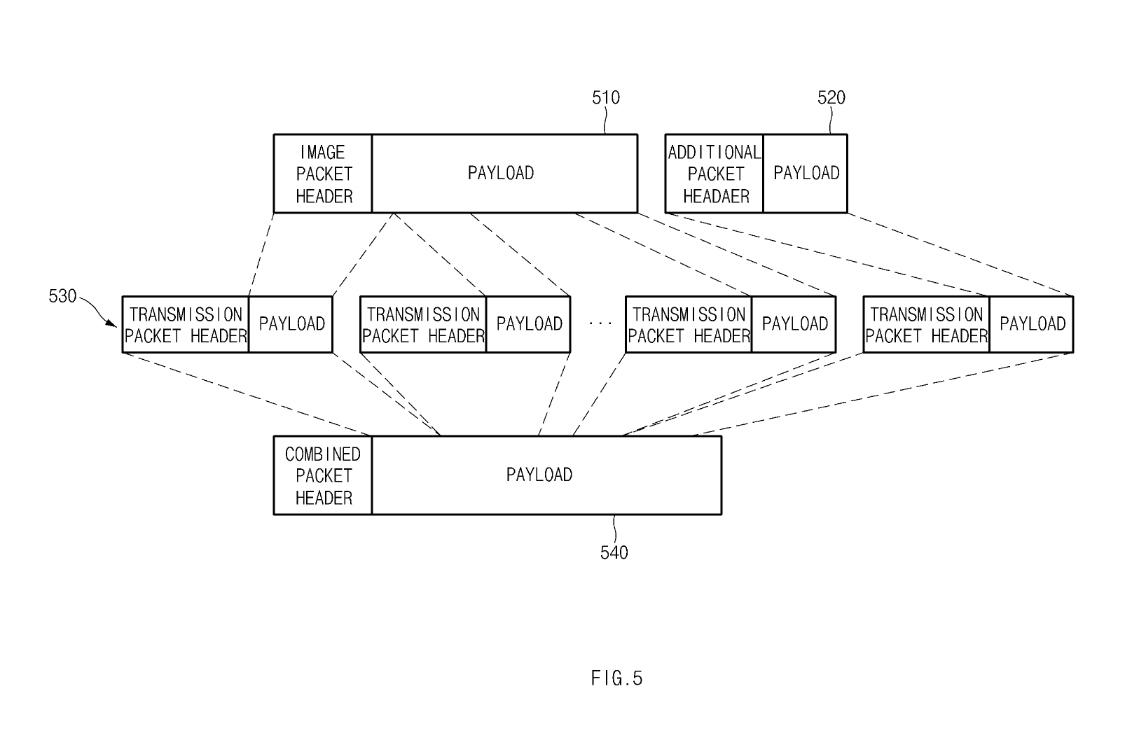

FIG. 5 is a diagram illustrating a packet configuration for describing a process of converting an image packet, according to an embodiment of the present invention.

Referring to FIG. 5, an image packet 510 or an additional packet 520 is successively streamed. A transmission packet 530 is a packet obtained by converting the image packet 510 or the additional packet 520 so that the image packet 510 or the additional packet 520 is easily transmitted/received in a communication network environment. The image packet 510 is converted into at least one transmission packet 530. The transmission packet 530 has a form obtained by dividing the image packet 510 into certain sections and adding a header to each section. In the case where the image packet 510 includes a relatively large amount of image data, the image packet 510 may correspond to a plurality of transmission packets 530. In the case where the image packet 510 includes a relatively small amount of image data, the image packet 510 may correspond to a small number of transmission packets 530. The transmission packet corresponds to a TS according to MPEG-2.

The additional packet 520 is converted into at least one transmission packet 530. The transmission packet 530 has a form obtained by adding a header to the additional packet 520. In the case where a data size of the additional packet 520 is not greater than a preset value, the additional packet 520 is converted into a single transmission packet 530. For example, in the case where the size of a transmission packet according to MPEG-2 is 188 bytes, the transmission packet 530 may include a transmission packet header having a size of 4 bytes and a transmission packet payload having a size of 184 bytes. The transmission packet payload having a size of 184 bytes may include an additional packet header having a size of 9 bytes and an additional packet payload having a size of 175 bytes. The packetizing module 220 adds data (e.g., image information or text information) related to the image packet 510 to the payload of the additional packet 520.

The transmission packets 530 may be combined according to an additional transmission protocol to improve the transmission efficiency or stability. For example, the transmission packets 530 may be combined into a single combined packet 540 according to a Real Time Transport Protocol (RTP). The combined packet 540 may sequentially add, to a payload thereof, the transmission packets 530 for the image packet 510 or the additional packet 520. Here, the RTP is merely an example, and thus, a combination or transmission scheme for the transmission packets 530 is not limited thereto.

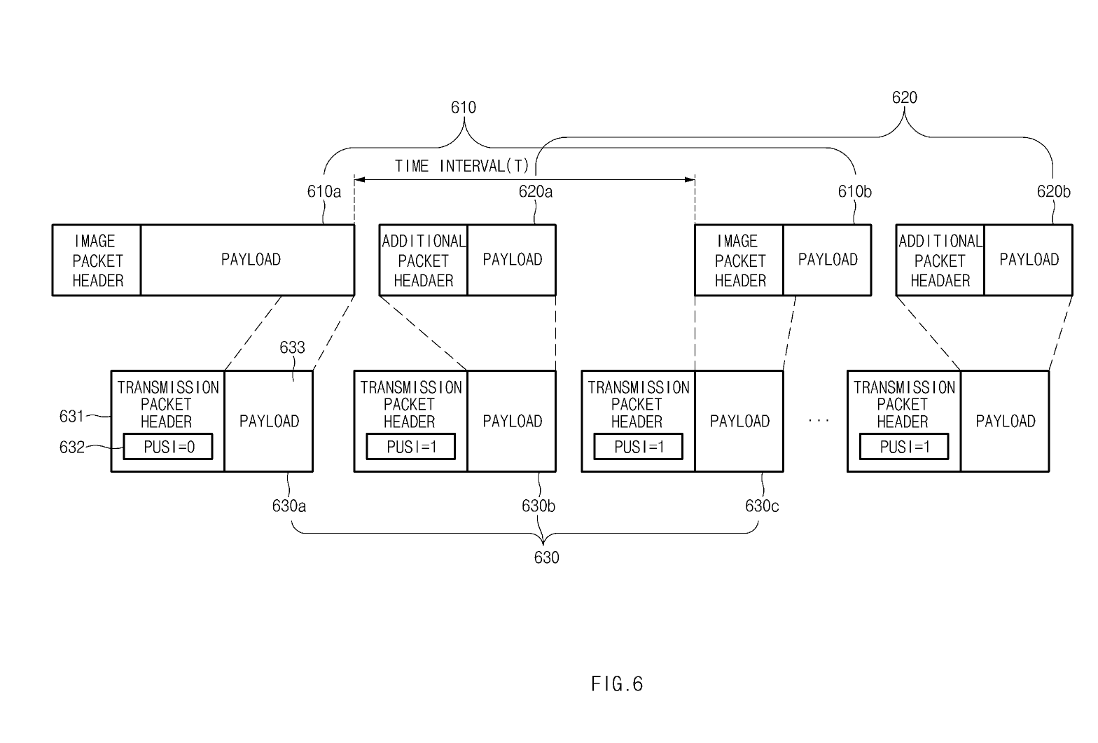

FIG. 6 is a diagram illustrating a packet configuration for indicating a change of a packet start indicator in a packet stream, according to an embodiment of the present invention.

Referring to FIG. 6, an image packet 610 or an additional packet 620 is converted into a transmission packet 630. The transmission packet 630 includes a header 631 and a payload 633. The header 631 includes a packet start indicator (e.g., a Payload Unit Start Indicator (PUSI)) 632. The packet start indicator 632 indicates whether data included in the payload 633 corresponds to a start point of the image packet 610. An external electronic device 102 or 103 receives the transmission packet 630 and checks the packet start indicator 632 included in the header 631. In the case where the packet start indicator 632 indicates a start of a new image packet, the external electronic device processes a currently received image packet 610. The packet start indicator 632 may correspond to a PUSI according to MPEG-2.

For example, in the case where the packet start indicator 632 is such configured that a start of an image packet is indicated by a value of 1 of the packet start indicator 632, the packet start indicator 632 of a transmission packet 630a may be set to be 0 (e.g., PUSI=0) since the transmission packet 630a includes image data corresponding to an end of an image packet 610a. Since a transmission packet 630c includes image data corresponding to a start part of an image packet 610b, the packet start indicator 632 may be set to be 1 (e.g., PUSI=1).

When an external electronic device (e.g., the electronic device 102 or the server 103) receives a transmission packet 630b (obtained by converting the additional packet 620a) of which the packet start indicator 632 is set to be 1, the external electronic device determines a boundary of the image packet 610a and processes the received image packet 610a. In this case, it is unnecessary to wait for the transmission packet 630c, and thus, data is processed without an additional time delay.

On the contrary, in the case where the additional packet 620 does not exist, as in the prior art, even though the external electronic device has received the transmission packet 630a and is able to process the image packet 610a, the external electronic device is unable to check the end of the corresponding packet and thus should wait to receive the transmission packet 630c transmitted thereafter. In this case, the external electronic device checks the transmission packet 630c received after a lapse of the time interval T and processes the image packet 610. Therefore, there may occur a delay of the time interval T.

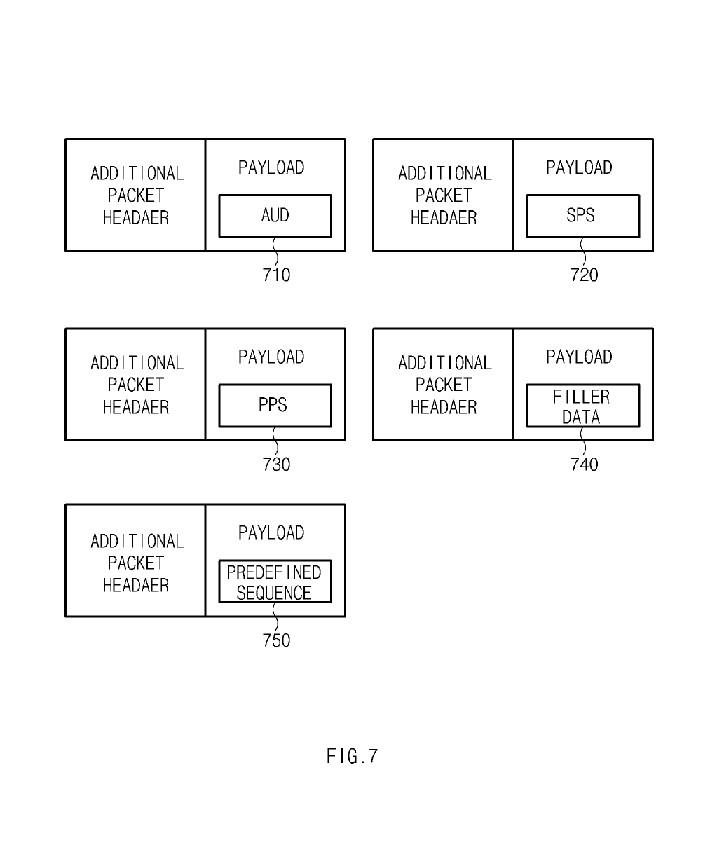

FIG. 7 is a diagram illustrating a packet configuration for showing a format of data included in a payload of an additional packet, according to an embodiment of the present invention.

Referring to FIG. 7, the payload of the additional packet includes at least one of an Access Unit Delimiter (AUD) 710, a Sequence Parameter Set (SPS) 720, a Picture Parameter Set (PPS) 730, a filler data 740, and a predefined sequence 750.

The AUD 710 corresponds to information indicating the head of an access unit.

The SPS 720 corresponds to information associated with encoding of an entire sequence such as a profile and a level.

The PPS 730 corresponds to information on an encoding mode (e.g., an entropy encoding mode) of an entire picture.

The filler data 740 is redundant data used to complete a format.

The AUD 710, SPS 720, PPS 730, or filler data 740 may correspond to data generated in a network abstraction layer (NAL) during an image encoding process by an H.264 codec. The AUD 710, SPS 720, PPS 730, or filler data 740 may correspond to incidental information other than image data, and does not affect the playback of an image even though the AUD 710, SPS 720, PPS 730, or filler data 740 is received by an external electronic device since the AUD 710, SPS 720, PPS 730, or filler data 740 has a small size compared to the image data.

The predefined sequence 750 represents a specific sequence having a value indicating an additional packet. The predefined sequence corresponds to a pre-defined value between the electronic device 101 and an external electronic device 102 or 103.

The AUD 710, SPS 720, PPS 730, filler data 740, or predefined sequence 750 is merely an example of data included in a payload of an additional packet. Therefore, data other than the data illustrated in FIG. 7 may be included in the payload of the additional data.

The additional packet includes incidental data desired to be added to image data. The additional packet may include audio data, text data or UI data. For example, the additional packet may include UI data about a method of controlling images, which may be output at the same time as when the images are streamed. In another example, the additional packet may include game data, a screen for manipulation, or text or voice data of a user, output at the same time as when game images are output.

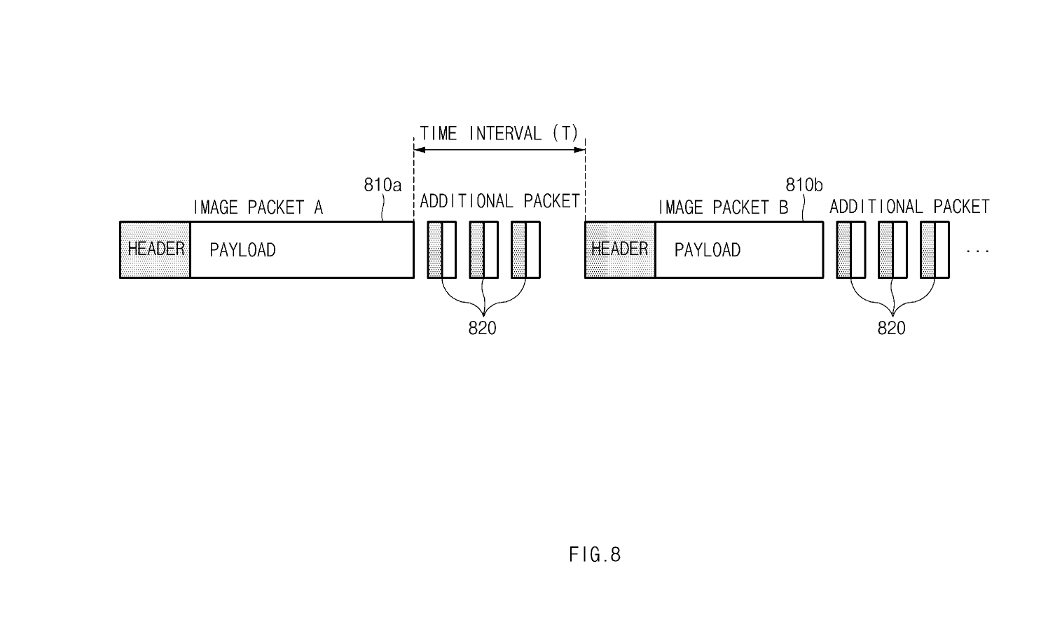

FIG. 8 is a diagram illustrating a packet streaming configuration when a plurality of additional packets is added within a predetermined time interval, according to an embodiment of the present invention.

Referring to FIG. 8, a plurality of additional packets 820 are transmitted during a time interval T, between an image packet 810a and an image packet 810b. The additional packets may be implemented in the same format or different formats of data. For example, all of additional packets 820a to 820c may be implemented into AUD-type data. Alternatively, the additional packet 820a may be implemented into AUD-type data, and the additional packet 820b or 820c transmitted thereafter may be implemented into filler data.

An external electronic device 102 or 103 checks additional packets that are processed within a preset time range (e.g., the time interval T), from among the plurality of received additional packets 820, and the external electronic device does not perform data processing for the additional packets outside the time range. For example, even though the external electronic device receives all the plurality of additional packets 820, the external electronic device may check only first and second additional packets that are processed within the time interval T, and preferentially receives and processes an image packet received thereafter. The external electronic device preferentially processes data substantially output to a screen, thereby improving the efficiency of image streaming.

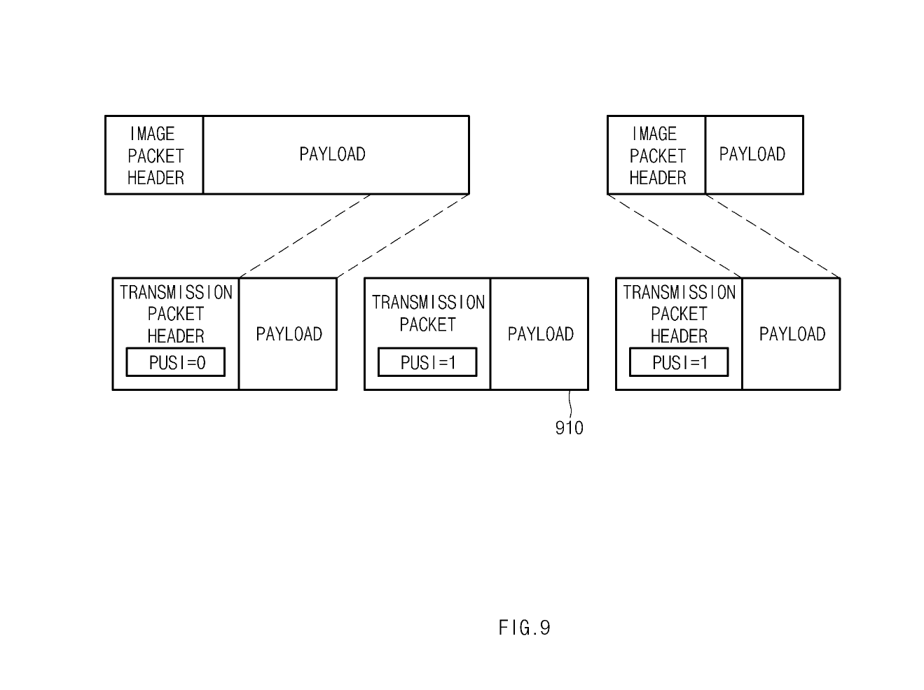

FIG. 9 is a diagram illustrating a packet streaming configuration when an additional packet is added by a transmission packet generating module, according to an embodiment of the present invention.

Referring to FIG. 9, when the packetizing module 220 does not generate an additional packet, the transmission packet generating module 230 directly generates an additional packet in the form of a transmission packet. In this case, the additional packet has the format of a header and payload of a transmission packet. The transmission packet generating module 230 generates an additional packet 910 including a payload containing a preset content (e.g., AUD, PPS, filler data, etc.). The additional packet 910 has the same operation or function as the above-mentioned operation or function of the additional packet generated by the packetizing module 220.

FIG. 10 is a block diagram illustrating a video receiving module included in an external electronic device for receiving images, according to an embodiment of the present invention.

Referring to FIG. 10, a video receiving module 1000 includes a communication module 1010, a transmission packet converting module 1020 and a decoding module 1030.

The communication module 1010 receives a transmission packet from an electronic device (e.g., the electronic device 101) which streams images. The transmission packet received by the communication module 1010 may include data on an image packet including image data or an additional packet indicating an image packet boundary. The communication module 1010 receives the transmission packet for the additional packet after receiving the transmission packet for the image packet. The video receiving module 1000 may not include the communication module 1010, but may use a communication interface for performing data communication in the external electronic device to perform data communication with an electronic device 101 that streams images.

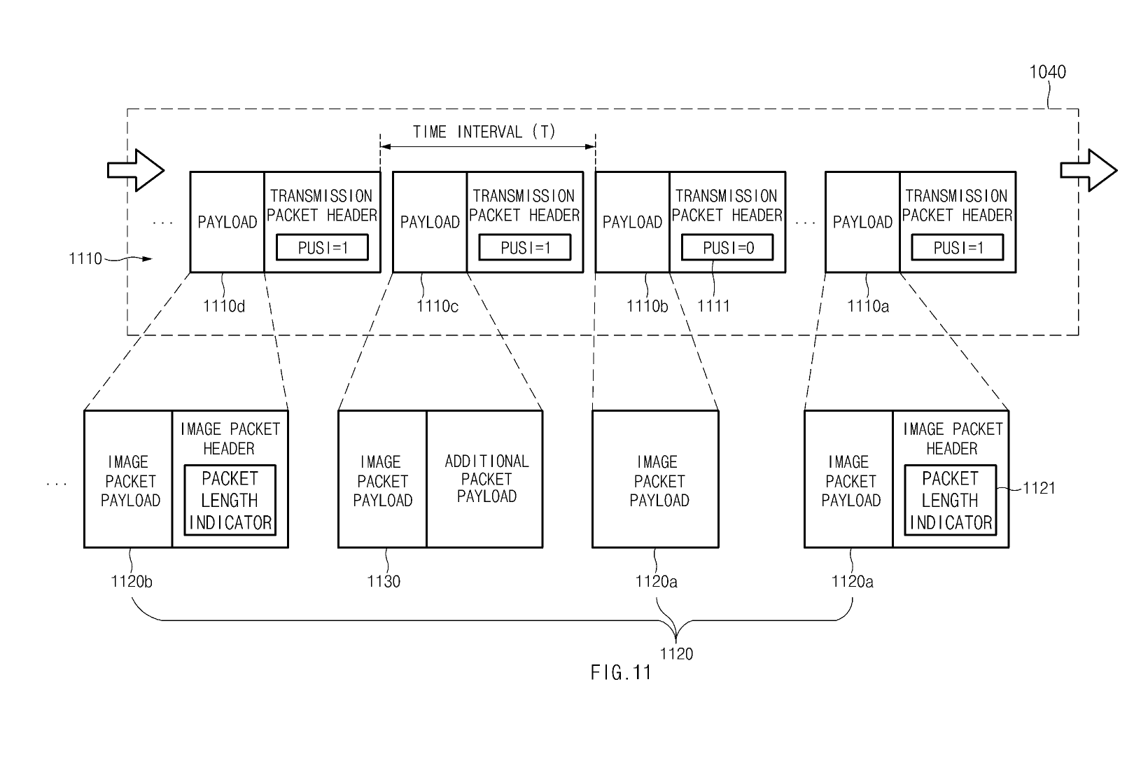

The transmission packet converting module 1020 converts the received transmission packet into an image packet or an additional packet. The transmission packet converting module 1020 checks a packet start indicator included in the header of the transmission packet to implement the image packet or the additional packet. The transmission packet converting module 1020 uses the additional packet received after the image packet to determine a data end point of the image packet and to configure the image packet. The transmission packet converting module 1020 will be described in more detail with reference to FIG. 11.

The decoding module 1030 extracts image information from the image packet configured by the transmission packet converting module 1020. The decoding module 1030 removes a head part from the image packet to configure the image information. The image information may include screen information or audio information related to frames of streamed images.

The video receiving module 1000 may further include a buffer 1040. The buffer 1040 stores the transmission packet received by the communication module 1010 until the transmission packet is processed by the transmission packet converting module 1020. The buffer 1040 operates in a First In First out (FIFO) manner. The buffer 1040 sequentially stores transmission packets for an image packet, and stores transmission packets for an additional packet received thereafter. When a boundary of an image packet previously received by the transmission packet converting module 1020 is determined, the buffer 1040 provides, to the decoding module 1030, transmission packets received prior to a transmission packet corresponding to the boundary. The buffer 1040 will be described in more detail with reference to FIG. 11.

The above-mentioned classification of operation is merely a functional classification, and the operations of the video receiving module 1000 may be implemented by a single process. The video receiving module 1000 may further include a combined packet changing module for storing a plurality of transmission packets. The combined packet changing module converts each combined packet into a transmission packet. The combined packet may correspond to a packet according to a Real-time Transport Protocol (RTP).

FIG. 11 is a diagram illustrating a packet flow for describing processing of received transmission packets, according to an embodiment of the present invention.

Referring to FIG. 11, the buffer 1040 stores transmission packets 1110 sequentially received from the electronic device 101. The header of the transmission packet 1110 includes a packet start indicator 1111. In the case where the indicator indicates a start of an image packet (e.g., PUSI=1), the transmission packet converting module 1020 checks a packet length indicator 1121 of an image packet header included in a payload of a corresponding transmission packet. The transmission packet converting module 1020 combines a payload of a transmission packet corresponding to the length of the image packet determined according to the packet length indicator 1121 so as to extract the image packet.

When the packet length indicator is filled with a predetermined value (e.g., 0) and the length of the image packet exceeds predetermined length (e.g., 65535 bits), the transmission packet converting module 1020 sequentially checks the packet start indicators 1111 of the transmission packets 1110 received thereafter. The transmission packet converting module 1020 checks the packet start indicator 1111 of a transmission packet 1110c, corresponding to an additional packet 1130 received thereafter, and configures an image packet 1120a on the basis of a transmission packet 1110a or 1110b received prior to the transmission packet 1110c. The transmission packet converting module 1020 provides the configured image packet 1120a to the decoding module 1030. The buffer 1040 preferentially outputs the transmission packet 1110a received earlier than the other transmission packets, i.e., operates in a FIFO manner.

The transmission packet converting module 1020 check the packet start indicator 1111 included in the header of the transmission packet 1110 to configure the image packet 1120, without checking the packet length indicator 1121 of the image packet 1120. Referring to FIG. 11, for example, the transmission packet converting module 1020 continuously checks the packet start indicator 1111 of the transmission packet 1110, checks that the PUSI=1 for the transmission packet 1110c for the additional packet 1130, and determines the transmission packet 1110a or 1110b received prior to the corresponding transmission packet as a data range for a single image packet. In this manner, the transmission packet converting module 1020 determines a boundary of the image packet 1120 with reference to the additional packet 1130 regardless of a data size of the image packet 1120.

The transmission packet converting module 1020 uses to a transmission packet 1110d received after the transmission packet 1110c for the additional packet 1130 to configure the additional packet 1130. In this case, the transmission packet converting module 1020 refers to the packet start indicator 1111 included in the transmission packet 1110 to configure the image packet 1120 or the additional packet 1130, without differentiating the image packet 1120 from the additional packet 1130.

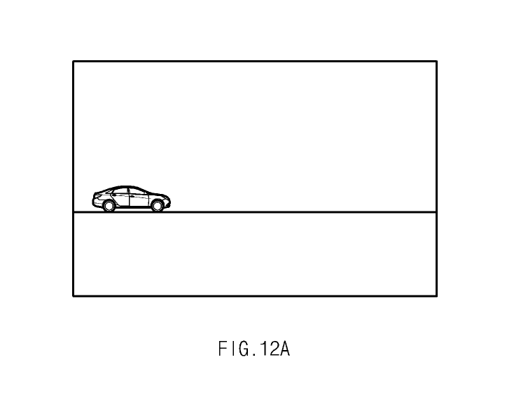

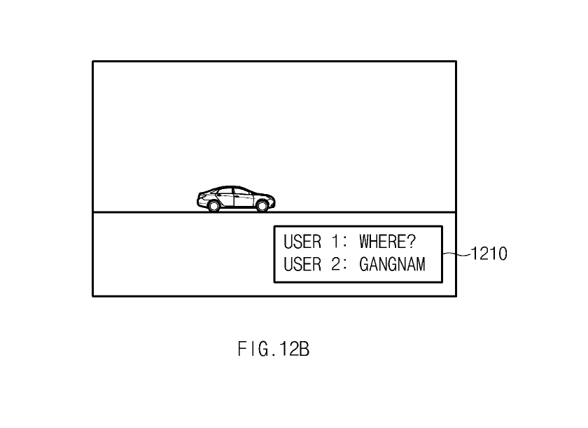

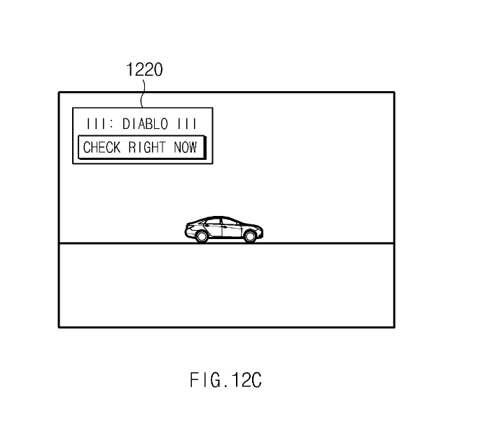

FIGS. 12A to C are diagrams illustrating screens of an electronic device, including data streamed in an additional packet, according to an embodiment of the present invention.

Referring to FIGS. 12A to 12C, these figures respectively correspond to screens including first to third frames of an imaged sequentially streamed by the electronic device.

Referring to FIG. 12A, the first frame displays a screen that is a basic image streamed by the electronic device 101. In this case, the additional packet includes data unrelated to images, such as filler data.

Referring to FIG. 12B, the second frame adds text data 1210 to the frame of the basic image streamed by the electronic device 101. In this case, the additional packet stores information on the text data 1210 in a payload. For example, the text data 1210 may correspond to a text message or a social networking service (SNS) message.

Referring to FIG. 12C, the third frame further adds an image 1220 to the frame of the basic image streamed by the electronic device 101. In this case, the additional packet stores data on the image 1220 in a payload. For example, the image 1220 may correspond to a picture, an animated emoticon, or an advertisement banner.

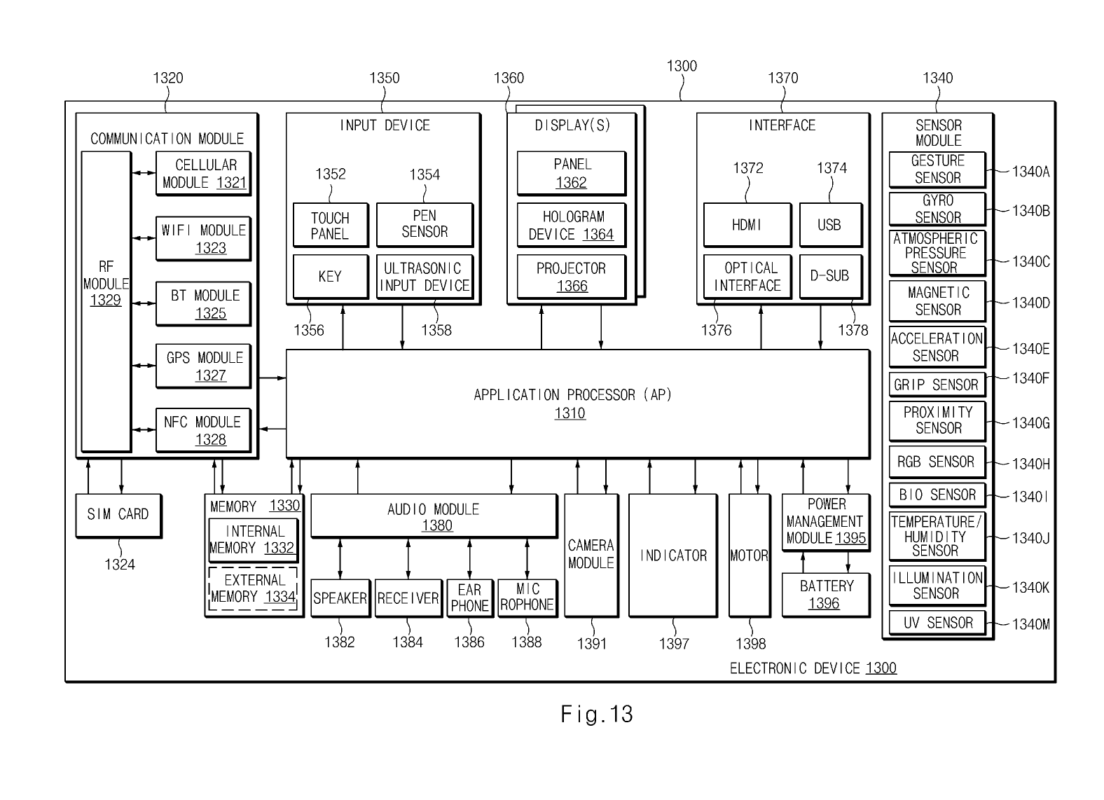

FIG. 13 is a block diagram illustrating an electronic device, according to an embodiment of the present invention.

Referring to FIG. 13, electronic device 1300 is provided. The electronic device 1300 may constitute, for example, a part or the entirety of the electronic device 101 illustrated in FIG. 1.

The electronic device 1300 includes at least one Application Processor (AP) 1310, a communication module 1320, a Subscriber Identification Module (SIM) card 1324, a memory 1330, a sensor module 1340, an input device 1350, a display 1360, an interface 1370, an audio module 1380, a camera module 1391, a power management module 1395, a battery 1396, an indicator 1397 and a motor 1398.

The AP 1310 runs an operating system or an application program to control a plurality of hardware or software elements connected to the AP 1310, and processes various data including multimedia data and performs an operation. The AP 1310 is implemented with, for example, a System on Chip (SoC). The AP 1310 may further include a Graphic Processing Unit (GPU, not illustrated).

The communication module 1320 (e.g., the communication interface 160, as shown in FIG. 1) performs data transmission/reception for communication between the electronic device 1300 (e.g., the electronic device 101, as shown in FIG. 1) and another electronic device (e.g., the electronic device 102, as shown in FIG. 1) connected thereto through a network. The communication module 1320 may include a cellular module 1321, a WiFi module 1323, a BT module 1325, a GPS module 1327, an NFC module 1328, and a Radio Frequency (RF) module 1329.

The cellular module 1321 provides a voice call service, a video call service, a text message service, or an Internet service through a communications network (e.g., LTE, LTE-A, CDMA, WCDMA, UMTS, WiBro or GSM network). Furthermore, the cellular module 1321 identifies and authenticates electronic devices in the communications network using, for example, a subscriber identification module (e.g., the SIM card 1324). According to an embodiment, the cellular module 1321 performs at least a part of functions provided by the AP 1310. For example, the cellular module 1321 may perform at least a part of a multimedia control function.

The cellular module 1321 may include a Communication Processor (CP). The cellular module 1321 may be implemented with, for example, an SoC. Although FIG. 13 illustrates that the cellular module 1321 (e.g., a CP), the memory 1330, and the power management module 1395 are separated from the AP 1310, the AP 1310 may include at least a part of the foregoing elements (e.g., the cellular module 1321).

The AP 1310 or the cellular module 1321 (e.g., a communication processor) loads, on a volatile memory, a command or data received from a nonvolatile memory connected to the AP 1310 or the cellular module 1321 or at least one of other elements, so as to process the command or data. Furthermore, the AP 1310 or cellular module 1321 stores, in the nonvolatile memory, data received from or generated by at least one of the other elements.

Each of the WiFi module 1323, the BT module 1325, the GPS module 1327, and the NFC module 1328 may include, for example, a processor for processing data transmitted/received through the modules. FIG. 13 illustrates the cellular module 1321, the WiFi module 1323, the BT module 1325, the GPS module 1327, and the NFC module 1328 as if the modules are separate blocks. However, according to an embodiment, at least a part (e.g., two or more) of the cellular module 1321, the WiFi module 1323, the BT module 1325, the GPS module 1327, and the NFC module 1328 may be included in a single Integrated Chip (IC) or IC package. For example, at least a part (e.g., a communication processor corresponding to the cellular module 1321 and a WiFi processor corresponding to the WiFi module 1323) of the cellular module 1321, the WiFi module 1323, the BT module 1325, the GPS module 1327, and the NFC module 1328 may be implemented with a single SoC.

The RF module 1329 transmits/receives data, for example, the RF module 1329 may transmit/receive an RF signal. A transceiver, a power amp module (PAM), a frequency filter or a low noise amplifier (LNA) may be included in the RF module 1329. Furthermore, the RF module 1329 may further include a component such as a conductor or a wire for transmitting/receiving free-space electromagnetic waves in a wireless communication system. FIG. 13 illustrates the cellular module 1321, the WiFi module 1323, the BT module 1325, the GPS module 1327, and the NFC module 1328 as if the modules share the single RF module 1329. However, at least one of the cellular module 1321, the WiFi module 1323, the BT module 1325, the GPS module 1327, and the NFC module 1328 may transmit/receive RF signals through an additional RF module.

The SIM card 1324 includes a subscriber identification module, and is inserted into a slot formed at a specific location of the electronic device 1300. The SIM card 1324 includes unique identification information (e.g., an Integrated Circuit Card Identifier (ICCID)) or subscriber information (e.g., International Mobile Subscriber Identity (IMSI)).

The memory 1330 (e.g., the memory 130) may include an internal memory 1332 or an external memory 1334. The internal memory 1332 includes at least one of a volatile memory (e.g., a dynamic RAM (DRAM), a static RAM (SRAM) or a Synchronous Dynamic RAM (SDRAM)) and a nonvolatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, or a NOR flash memory).

The internal memory 1332 may be a Solid State Drive (SSD).

The external memory 1334 may include a flash drive, for example, Compact Flash (CF), Secure Digital (SD), Micro Secure Digital (Micro-SD), Mini Secure Digital (Mini-SD), extreme Digital (xD) or a memory stick. The external memory 1334 may be functionally connected to the electronic device 1300 through various interfaces. The electronic device 1300 may further include a storage device (or a storage medium) such as a hard drive.

The sensor module 1340 measures physical quantity or detects an operation state of the electronic device 1300 to convert measured or detected information into an electrical signal. The sensor module 1340 includes at least one of a gesture sensor 1340A, a gyro sensor 1340B, an atmospheric pressure sensor 1340C, a magnetic sensor 1340D, an acceleration sensor 1340E, a grip sensor 1340F, a proximity sensor 1340G, a color sensor 1340H (e.g., RGB sensor), a biometric sensor 1340I, a temperature/humidity sensor 1340J, an illuminance sensor 1340K, and an ultraviolet (UV) sensor 1340M. Additionally or alternatively, the sensor module 1340 may include, for example, an olfactory sensor (E-nose sensor, an electromyography (EMG) sensor, an electroencephalogram (EEG) sensor, an electrocardiogram (ECG) sensor, an infrared (IR) sensor, an iris recognition sensor, or a fingerprint sensor. The sensor module 1340 further include a control circuit for controlling at least one sensor included therein.

The input device 1350 includes a touch panel 1352, a (digital) pen sensor 1354, a key 1356, or an ultrasonic input device 1358.

The touch panel 1352 recognizes a touch input using at least one of capacitive, resistive, infrared, and ultraviolet sensing methods. The touch panel 1352 may further include a control circuit. In the case of using the capacitive sensing method, a physical contact recognition or proximity recognition is allowed. The touch panel 1352 may further include a tactile layer. In this case, the touch panel 1352 provides tactile reaction to a user.

The (digital) pen sensor 1354 may be implemented in a similar or same manner as that for receiving a touch input of a user, or may be implemented using an additional sheet for recognition.

The key 1356 may include, for example, a physical button, an optical button, or a keypad.

The ultrasonic input device 1358, which is an input device for generating an ultrasonic signal, enables the electronic device 1300 to sense a sound wave through a microphone (e.g., a microphone 1388) to identify data. The ultrasonic input device 1358 is capable of wireless recognition. The electronic device 1300 may use the communication module 1320 to receive a user input from an external electronic device (e.g., a computer or server) connected to the communication module 1320.

The display 1360 (e.g., the display 150, as shown in FIG. 1) includes a panel 1362, a hologram device 1364, or a projector 1366.

The panel 1362 may be, for example, a Liquid Crystal Display (LCD) or an Active-Matrix-Organic Light-Emitting Diode (AM-OLED). The panel 1362 may be, for example, flexible, transparent or wearable. The panel 1362 and the touch panel 1352 may be integrated into a single module.

The hologram device 1364 displays a stereoscopic image in a space using a light interference phenomenon.

The projector 1366 projects light onto a screen to display an image. The screen may be arranged in the inside or the outside of the electronic device 1300.

The display 1360 may further include a control circuit for controlling the panel 1362, the hologram device 1364, or the projector 1366.

The interface 1370 include, for example, a High Definition Multimedia Interface (HDMI) 1372, a Universal Serial Bus (USB) 1374, an optical interface 1376, or a D-subminiature (D-sub) 1378.

The interface 1370 may be included in the communication interface 160 illustrated in FIG. 1. Additionally or alternatively, the interface 1370 may include, for example, a Mobile High-definition Link (MHL) interface, a SD card/Multi-Media Card (MMC) interface, or an Infrared Data Association (IrDA) interface.

The audio module 1380 converts a sound into an electrical signal or vice versa. A part of the audio module 1380 may be included in the input/output interface 140 illustrated in FIG. 1. The audio module 1380 processes sound information input or output through a speaker 1382, a receiver 1384, an earphone 1386, or the microphone 1388.

The camera module 1391 for shooting a still image or a video may include at least one image sensor (e.g., a front sensor or a rear sensor), a lens, an Image Signal Processor (ISP), or a flash (e.g., an LED or a xenon lamp).

The power management module 1395 manages power of the electronic device 1300. A Power Management Integrated Circuit (PMIC), a charger Integrated Circuit (IC), or a battery gauge may be included in the power management module 1395.

The PMIC is mounted on an integrated circuit or SoC semiconductor. A charging method may be classified into a wired charging method and a wireless charging method.

The charger IC charges a battery, and prevents an overvoltage or an overcurrent from being introduced from a charger. The charger IC includes a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier.

The battery gauge measures, for example, a remaining capacity of the battery 1396 and a voltage, current or temperature thereof while the battery is charged. The battery 1396 stores or generates electricity, and supplies power to the electronic device 1300 using the stored or generated electricity. The battery 1396 may include, for example, a rechargeable battery or a solar battery.

The indicator 1397 displays a specific state of the electronic device 1300 or a part thereof (e.g., the AP 1310), such as a booting state, a message state, or a charging state. The motor 1398 converts an electrical signal into a mechanical vibration. Although not illustrated, a processing device (e.g., a GPU) for supporting a mobile TV may be included in the electronic device 1300. The processing device for supporting a mobile TV may process media data according to the standards of Digital Multimedia Broadcasting (DMB), Digital Video Broadcasting (DVB) or media flow.

Each of the above-mentioned elements of the electronic device according to the various embodiments of the present invention may be configured with one or more components, and the names of the elements may be changed according to the type of the electronic device. The electronic device, according to the embodiments of the present invention, may include at least one of the above-mentioned elements, and some elements may be omitted or other additional elements may be added. Furthermore, some of the elements of the electronic device, according to the various embodiments of the present invention, may be combined with each other to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” according, to the embodiments of the present invention, may include at least one of an Application-Specific Integrated Circuit (ASIC) chip, a Field-Programmable Gate Array (FPGA), and a programmable-logic device for performing some operations, which are known or will be developed.

According to the embodiments of the present invention, at least a part of devices (e.g., modules or functions thereof) or methods (e.g., operations) may be implemented as instructions stored in a computer-readable storage medium in the form of a programming module. In the case where the instructions are performed by at least one processor (e.g., the processor 1310), the at least one processor may perform functions corresponding to the instructions. The computer-readable storage medium may be, for example, the memory 630. At least a part of the programming module may be implemented (e.g., executed) by the processor 1310. At least a part of the programming module may include, for example, a module, program, routine, sets of instructions, or process for performing at least one function.

The computer-readable storage medium may include a magnetic medium such as a hard disk, a floppy disk and a magnetic tape, an optical medium such as a Compact Disk Read Only Memory (CD-ROM) and a Digital Versatile Disc (DVD), a magneto-optical medium such as a floptical disk, and a hardware device configured to store and execute program instructions (e.g., programming module), such as a ROM, a RAM and a flash memory. The program instructions may include machine language codes made by compilers and high-level language codes that can be executed by computers using interpreters. The above-mentioned hardware may be configured to be operated as one or more software modules for performing operations of the present invention and vice versa.

According to the embodiments of the present invention, in a non-transitory computer-readable storage medium having instructions for controlling an electronic device, the instructions may allow the electronic device to perform generating image information related to a frame of an image, generating an image packet by packetizing the generated image information, transmitting a transmission packet corresponding to the image packet, and transmitting at least one transmission packet corresponding to an additional packet for indicating a boundary of the image packet.

The module or programming module according to the present invention may include at least one of the above-mentioned elements, or some elements may be omitted or other additional elements may be added. Operations performed by the module, the programming module or the other elements may be performed in a sequential, parallel, iterative or heuristic way. Furthermore, some operations may be performed in another order or may be omitted, or other operations may be added.

As described above, according to the various embodiments of the present invention, image signal data can be processed without delay by adding a predetermined packet between image signal data.

According to the various embodiments of the present invention, a predetermined packet between image signal data is transmitted so that the packet can be used to determine a boundary of an image signal or transmit related data.

The above embodiments of the present invention are illustrative and not limitative. Various alternatives and equivalents are possible. Other additions, subtractions, or modifications are obvious in view of the present disclosure and are intended to fall within the scope of the appended claims and their equivalents.

What is claimed is:

1. A video streaming method comprising:
generating image information related to a frame of an image;
generating an image packet by packetizing the generated image information;
transmitting a transmission packet corresponding to the image packet; and
transmitting at least one transmission packet corresponding to an additional packet for indicating a boundary of the image packet.

2. The video streaming method according to claim 1, further comprising transmitting a transmission packet corresponding to an image packet for image information related to another frame following the frame.

3. The video streaming method according to claim 1, wherein the additional packet has a size enabling the additional packet to be transmitted within a preset time interval related to a characteristic of the image.

4. The video streaming method according to claim 1, wherein the additional packet comprises a header and a payload, wherein the header includes an indicator indicating a boundary of the image packet.

5. The video streaming method according to claim 1, wherein the additional packet includes at least one of audio data, image data, text data, animated emoticon, and user interface (UI) data, which is able to be output together with the image.

6. The video streaming method according to claim 1, wherein the additional packet includes at least one of an Access Unit Delimiter (AUD), a Sequence Parameter Set (SPS), a Picture Parameter Set (PPS), filler data, and a predefined sequence in a payload field.

7. The video streaming method according to claim 1, wherein the image information corresponds to an Elementary Stream (ES) according to Moving Picture Experts Group-2 (MPEG-2), the image packet corresponds to a Packetized Elementary Stream (PES), and the transmission packet corresponds to a Transport Stream (TS).

8. A video streaming method comprising:
receiving a transmission packet for an image packet related to a frame of an image;
receiving a transmission packet corresponding to an additional packet indicating a boundary of the image packet;
extracting the image packet with reference to the additional packet; and
configuring the image on the basis of the image packet.

9. The video streaming method according to claim 8, wherein extracting the image packet comprises determining a size of the image packet with reference to an indicator, indicating the boundary of the image packet, included in a header of the transmission packet corresponding to the additional packet.

10. The video streaming method according to claim 9, wherein determining a size of the image packet comprises referring to the indicator when the size of the image packet exceeds a preset length.

11. The video streaming method according to claim 8, further comprising extracting the additional packet after receiving a transmission packet for an image packet related to a next frame following the frame.

12. An electronic device comprising:
an encoding module configured to generate image information related to a frame of an image;
a packetizing module configured to generate an image packet by packetizing the generated image information;
a transmission packet generating module configured to generate a transmission packet corresponding to the image packet; and
a communication interface configured to transmit the transmission packet to another electronic device, and after the transmission packet is transmitted, to transmit at least one transmission packet corresponding to an additional packet for indicating a boundary of the image packet.

13. An electronic device comprising:
a communication module configured to receive a transmission packet for an image packet related to a frame of an image, and after receiving the transmission packet for the image packet, to receive a transmission packet corresponding to an additional packet for indicating a boundary of the image packet;
a transmission packet converting module configured to extract the image packet from the transmission packet and to refer to the additional packet to configure the image packet; and
a decoding module configured to extract image information related to the frame from the image packet.

14. A non-transitory computer-readable storage medium having instructions recorded thereon for controlling an electronic device, the instructions allowing the electronic device to perform:
generating image information related to a frame of an image;
generating an image packet by packetizing the generated image information;
transmitting a transmission packet corresponding to the image packet; and
transmitting at least one transmission packet corresponding to an additional packet for indicating a boundary of the image packet.
